(19) United States
(12) Patent Application Publication
(10) Pub. No.: US 2022/0381386 A1
(43) Pub. Date: Dec. 1, 2022

(54) HIGH PRESSURE QUICK CONNECT FLUID COUPLING AND GASKET FOR SEALING COUPLING

(71) Applicant: BE THE CHANGE LABS, INC., New York, NY (US)

(72) Inventor: Grant Kenji LARSEN, New York, NY (US)

(21) Appl. No.: 17/755,952

(22) PCT Filed: Nov. 11, 2020
(86) PCT No.: PCT/US2020/060007

§ 371 Date: May 12, 2022

Related U.S. Application Data
(60) Provisional application No. 62/934,221, filed on Nov. 12, 2019.

(51) Int. Cl. F16L 37/252; F16J 15/02

(52) U.S. Cl. CPC F16L 37/252; F16J 15/022

(57) ABSTRACT

A fluid coupling has engagement unit retained by a retention unit. The engagement unit has an outer surface having ears, and the retention unit has an interior surface for surrounding a portion of the engagement unit. The interior surface has pockets corresponding to the ears, and each pocket retains a corresponding ear. When the engagement unit is moved in an engagement direction, each ear passes a sidewall of a corresponding pocket and can be rotated and released to rest in the corresponding pocket. The ears may comprise sloped surfaces angled relative to a horizontal plane perpendicular to a length of the engagement unit. The fluid coupling may further comprise a gasket having a bearing surface for bearing against an end of the engagement unit, a base element for fixing the sealing gasket relative to the retention unit, and a flexible membrane extending from the base element to the bearing surface.

### CROSS-REFERENCE TO RELATED APPLICATIONS

This application claims the benefit of U.S. Provisional Application No. 62/934,221, filed Nov. 12, 2019, the contents of which are incorporated by reference herein.

### FIELD OF THE INVENTION

The invention relates to rigid couplings for coupling pressurized gas sources to lower pressure outlets.

### BACKGROUND

Existing methods of high pressure seals have severe drawbacks in ease of use, and this can negatively affect not only function, but also safety factors. For use in the home, by people not trained in the technology of high pressure gas containment, it is important to make a foolproof and safe system of fluid coupling. Further, increasing the ease of use of such a coupling reduces the chance of user error, which further increases the overall safety of the system.

Attachment of CO2 gas canisters to apparatuses utilizing pressurized gas is common. Uses such as paintball propellant and beverage carbonation are known. In each case, however, the typical fluid coupling is achieved by a conventional method of using a helical screw thread to attach separate parts, while such thread creates a tightening action that causes a flexible gasket material to form a seal. Speaking generally, such gasket may be integrated or separate from a housing, may be a polymeric material such as rubber or harder plastic, and may take the form of a flat washer, a lip seal, or an O-ring. Other variations may exist, but in each case there is a compression of the polymer material between mating sides of the coupling, and this physical compression force is applied by the tightening of the helical screw thread.

In order to make such thread strong enough to withstand the types of pressures that are achieved at these couplings, they must either be large in scale, and/or be fine threaded, such that multiple threads are engaged to bear the mechanical stress. In the case of fine threads, it is necessary to rotate the coupling through many rotations to engage a sufficient number of threads, as well as to create sufficient displacement, through helical travel, to compress the aforementioned seal. In the case of large scale threads, a smaller number of rotations may be required, as fewer threads are able to bear the entire load. However, seal compression must still occur, so to get sufficient helical travel, rotation is still necessary. Such displacement may be gained with fewer rotations if the screw angle is more pronounced (coarse threaded), however this arrangement is not optimal, because when fluid pressure is applied, the force leads to unscrewing the coupling, which is counter to the function, and a safety hazard.

Consequently, the known threaded couplings have the drawback that they must be rotated several times to engage properly and stay engaged under pressure. An additional drawback to this arrangement is that since there is typically a compression of a polymer seal, there is no certain point at which such couplers are known by a user to be tight enough. One may actuate the coupler and find it leaky, at which point it becomes apparent that it needs tightening. However, there is no user feedback that any amount of coupler engagement is sufficient or safe.

In the case of hose-based couplings, multiple rotations are highly inconvenient due to hoses, especially ones under high pressure, being unable to twist easily in that manner. Even with low-pressure hoses such as garden hoses conveying water, threaded couplings are troublesome, even if common. In some cases it is possible to put a rotating joint into a coupling to allow the hose to remain stationary while only the coupling rotates. This adds more seals prone to leakage, wear, and failure points. Consequently, low- or no-rotation quick connect couplers are common with hose couplings.

Quick connect hose couplings have different drawbacks. In the case of no-rotation couplers, a common scheme is to have a collar around the coupler that has a built in cam that retracts dogs or detents on one side of the coupler. These dogs may engage a groove or a lip on the other side of the coupling, holding it together when the collar is in the locked or closed position. These engagement dogs may take the form of ball bearings, which allow them to more easily slide into place. When such collar is backing such bearings, these lie in a groove, essentially creating a smaller lip diameter that grips the other side of the coupling. Such dogs may also be pins or sliding plates. While many such configurations exist, the ball bearing makes for a rolling contact that is meant to be easy to engage and connect.

Even so, this type of coupling has severe drawbacks. First, the described engagement is usually a metal-to-metal or at least rigid-material-to-rigid-material contact, for the purpose of mechanically securing the coupling and bearing the mechanical stress under pressure. Typically the no-rotation coupling still relies on a compressed polymer gasket or O-ring to provide the fluid seal, just as with the rotational coupling. One positive difference is that locking engagement has good user feedback and is well understood. Such locking coupler is either locked in place, with locking collar in an obvious position, or it is not fully or properly engaged, and this is visually obvious.

Nevertheless, the drawbacks continue. Usually the two sides of the engagement have tight tolerances, as they must in order to make a positive mechanical lock. This makes engagement difficult as near-perfect alignment of the mating parts is required. This can be extremely difficult with the weight of hoses attached. Repeated use and misalignment causes wear on both the mechanical engagement and the fluid seal parts. As one part must fit inside another, and in a different axis there must be retaining groove or lip engagement, and tolerances are tight, these couplings are easily compromised by temperature differences, material contamination, corrosion, or physical damage such as dents or wear. In the case of ball bearing dogs, all the mechanical stress is concentrated on as few as three points (contact points of the spherical ball bearings), leading to ball and lip damage, and increasing difficulty of engagement with repeated use and wear.

In a low-rotation coupling we have many of the same drawbacks, but an added feature known as the “twist-lock” or “bayonet” coupling. Typically there are two ears or pins that engage a mechanism, allowing a 90 degree turn to the coupling to lock the coupling in place. This added feature can increase safety by providing a physical lock, as well as making it visually obvious that the connection is in the proper position when coupled. It may also make it more difficult to de-couple the coupling under pressure, which is another safety benefit over the no-rotation coupling. However, since the locking mechanism usually involves an over-center motion to produce retention force, there is larger movement along the axial direction, and final position that is less inserted than the maximum over-center position. This results in over-compression of a gasket at that maximum point, with relative movement, leading to wear, especially in unlubricated conditions. In other incarnations of the twist lock, the seal is a circumferential one, allowing for sliding contact in an out, allowing the axial motion. This requires some space and a typically unprotected sealing surface, and suffers from contamination effects.

In the case of CO2 canisters for beverage appliances, but not limited to this case, it is advantageous to allow the layperson to connect a high pressure coupling in a safe and robust fashion. All of the above-described methods have drawbacks that make use of such connections less than optimal for a beverage appliance that should be easy to use, obvious to operate, and safe. Therefore a more convenient and robust coupling was developed, that has the advantages of low-rotation, ease of coupling with low coupling forces and large tolerances on alignment, obvious tactile feedback on completion of engagement, extreme difficulty of de-coupling while under pressure, resilience to contamination and wear, and ease of de-coupling when not under pressure.

### SUMMARY

This disclosure relates to rigid couplings that allows a high-pressure gas source to be secured and connected to a lower-pressure outlet that is easy to secure, locks under pressure, and is easy to decouple.

Further, the coupling is robust in that it does not rely upon mechanical compression of a seal between parallel surfaces, at indeterminate distances, to hold in the high pressure gas. Instead, it uses pressure of the gas itself to maintain the seal. Therefore, the higher the pressure, the more secure the coupling becomes, increasing the seal pressure, and increasing the ability to retain the gas.

In some embodiments, components of the coupling may include a valve on the high pressure side that has a convenient interlocking mechanism. The pressure source may be a contained source such as a compressed fluid canister, or it may be a continuous source, such as a hose end. The high pressure side may then contain a valve mechanism to allow the assembly to exist in a decoupled state without leaking pressurized contents.

The coupling may further comprise a receptacle that physically accepts the interlocking mechanism and a gasket that deflects under pressure, not only sealing the fluid coupling, but providing force to the interlocking mechanism to further secure it in a locked position.

The coupling may further comprise a mechanism to actuate the valve referenced above. This mechanism may exist on either the high or low pressure side. If on the high pressure side, it has the benefit of being able to be contained all on one side of the coupling. If on the low pressure side, it has the benefits of using lower pressure seals, and having the actuation mechanism remote from the high pressure, lowering the complexity and volume necessary to contain it.

In the embodiments discussed herein, the coupling generally comprises a retention unit and an engagement unit being retained by the retention unit. The engagement unit has an outer surface comprising a plurality of ears and the retention unti has an interior surface comprising a plurality of pockets corresponding to the plurality of ears, wherein each pocket retains a corresponding ear when engaged.

During use, the engagement unit is moved in an engagement direction such that each ear passes a sidewall of the corresponding pocket and is rotated in a first direction to engage with the retention unit. The engagement unit is rotated in a second direction opposite the first direction and moved in a disengagement direction opposite the engagement direction to disengage with the retention unit.

Each ear has a first surface on an engagement side adjacent the outer surface of the engagement unit and a second surface on a disengagement side opposite the engagement side adjacent the outer surface of the engagement unit. The second surface is angled relative to a horizontal plane perpendicular to a length of the engagement unit such that upon rotation of the engagement unit in the first direction, the second surface of each ear bears on a sidewall of the corresponding pocket and forces the engagement unit into engagement with the retention unit.

Generally, the second surface slopes from an engagement side to a disengagement side, wherein a transition from an engagement end of the slope closest to the first surface to a first side surface of the corresponding ear has a first radius, and wherein a transition from a disengagement end of the slope farthest from the first surface to a second side surface of the corresponding ear has a second radius larger than the first radius.

In some embodiments, the engagement unit comprises a valve and is associated with a pressurized fluid source, such that the valve releases pressurized fluid upon engagement with the retention unit.

In some embodiments, the first surface of each ear is chamfered relative to the horizontal plane of the engagement unit. In such embodiments, the retention unit may have a limiting surface having a chamber at a substantially similar angle to that of the ears.

In some embodiments, each pocket has a base surface, a first side surface, and a second side surface, where the first side surface extends from the base surface to a limiting surface of the retention unit and the second side surface extends only partially towards the limiting surface. In some embodiments, the base surface is angled relative to the horizontal plane such that it has a slope substantially similar to that of the second surface of the corresponding ear when the engagement unit is engaged.

In some embodiments, the retention unit has a sealing gasket chamber for locating a sealing gasket. In such embodiments, the fluid coupling play further comprise a sealing gasket. The sealing gasket may then have a bearing surface for bearing against an end of the engagement unit when the engagement unit is engaged by the retention unit, a base element for fixing the sealing gasket relative to the retention unit, and a flexible membrane extending from the base element to the bearing surface.

In embodiments with a gasket, when the sealing gasket chamber is pressurized by the retention unit, when under pressure, the bearing surface may be forced against the end of the engagement unit, and the flexible membrane may form an inflatable wall of the sealing gasket chamber.

In some embodiments, the bearing surface may be substantially circular, and the base element may be outside of a radius of the bearing surface. In such an embodiment, the base element may have a base surface for engagement the retention unit, and the base surface may be substantially perpendicular to the bearing surface.

In some embodiments, the bearing surface may be substantially circular, and may slope radially, such that it is angled downward relative to a central axis of the retention unit.

In some embodiments, the fluid coupling further comprises a spring within the sealing gasket chamber, where the spring biases the sealing gasket in the direction of the bearing surface.

In some embodiments, the gasket described is provided independently of the specific fluid coupling described and is as a fluid gasket in other implementations.

### BRIEF DESCRIPTION OF THE DRAWINGS

FIG. 1 shows a section view of a coupling in accordance with this disclosure.

FIGS. 2A and 2B are lower and upper perspective views of a portion of a coupling in accordance with this disclosure.

FIG. 3 shows a three eared arrangement for an engagement unit in accordance with this disclosure.

FIG. 4 shows an elevation view of an ear of the coupling.

FIG. 5 shows a perspective view of a retention unit in accordance with this disclosure.

FIG. 6 shows a cross section of one of the ears of FIG. 3.

FIG. 7 shows a view of an alternate retention unit in accordance with this disclosure.

FIG. 8 shows a sectioned view of the retention unit of FIG. 1 for retaining an engagement unit.

FIG. 9 shows a sectioned view of the retention unit of FIG. 1 for retaining an engagement unit including a sealing gasket.

FIG. 10 shows the retention unit of FIG. 9 mated with an engagement unit.

FIGS. 11A and 11B show the gasket in perspective and sectioned views respectively.

FIG. 12 shows a second view of the retention unit of FIG. 9.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

The coupling described herein is generally comprised of a high pressure side and a low pressure side. Typically, such a coupling would have a valve on the high pressure side. The coupling has a convenient interlocking mechanism including ears on an engagement unit and receptacles on a retention unit that physically accept the ears. In some embodiments, the coupling further comprises a specially shaped gasket that deflects under pressure, not only sealing the fluid coupling, but providing force to the interlocking mechanism to keep it secure, and a mechanism to actuate the valve on the high pressure side.

The valve in the high pressure side may be any valve, such as those employing a polyurethane gasket or O-ring to contain high pressure fluid. It will be understood that while the following discussion focuses on CO2, any compressed gas or liquid compressed gas may be used, and valve internals may differ depending on the contained fluid. The underlying assumption is that a valve exists on the high-pressure side of the coupling that is capable of containing the fluid under pressure when in a de-coupled state. A mechanism suitable to opening such a valve once the coupling is engaged may be integral to such valve, or it may not.

As a point of reference, we use as a basis a common beverage or paintball CO2 valve, which typically does not include such an actuation mechanism, and is typically comprised of a pin that is depressed by an external mechanism, that causes a polymer based gasket to be deflected away from a sealing surface, releasing the gas. This is similar to a conventional automotive tire inflation valve in form, but is specifically designed to operate under cryogenic conditions, as can occur with sublimating compressed liquids.

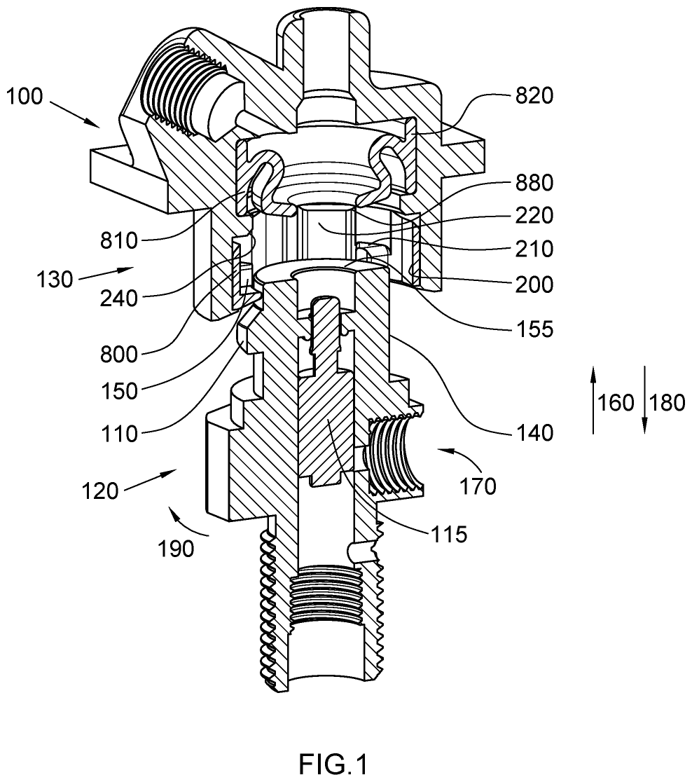

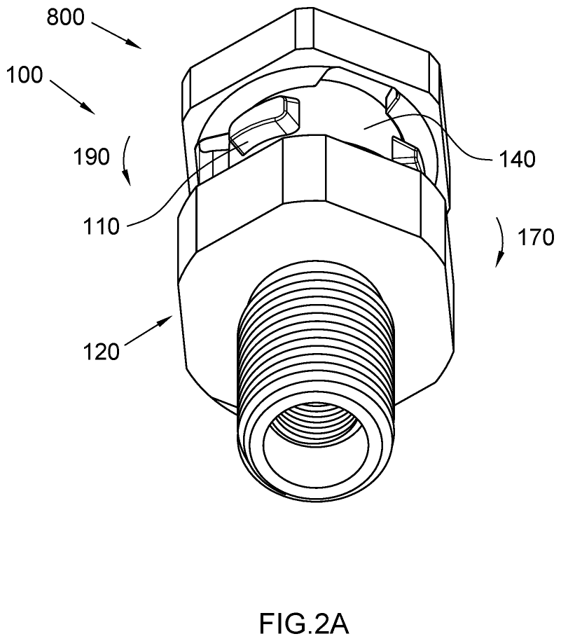

FIG. 1 shows a section view of a coupling 100 in accordance with this disclosure. FIGS. 2A and 2B are lower and upper perspective views of portions of a coupling 100 in accordance with this disclosure.

In the embodiments shown and described the coupling 100 includes an interlocking mechanism of a low-rotation type. In the embodiments shown, three ears 110 are provided, but the mechanisms described can be implemented with two ears or more ears as well. As such, the interlocking mechanism of the coupling 100 shown has three ears 110. Three contact points constitute a stable triangular plane, and hinging or pivoting possibilities are greatly reduced. A user inserting an engagement unit 120 containing a valve 115 with normal misalignment is likely to have contact points at two out of three points, instead of a single point, and as a pivot created by the two point axis is offset from the center of the engagement unit 120, it becomes natural and easy for the user to feel the alignment such that the third point engages properly. Such a configuration provides advantages over misalignment issues and stresses generated in two point interlock systems. Further, the numerous points of contact produce not only good user feedback of engagement, but also much less contact stress per point, reducing wear.

Also, the traditional two ear arrangement requires a 90 degree turn, whereas the three ear 110 arrangement shown requires only 60 degrees of rotation to engage. Similarly, insertion opportunities with the two ear arrangement are +/−90 degrees, whereas with the three-ear arrangement it is only +/−60 degrees. This makes the engagement unit much easier to insert, engage, disengage, and detach.

Accordingly, as shown, the fluid coupling 100 generally comprises a retention unit 130, referenced occasionally herein as a receptacle and discussed in more detail below, and an engagement unit 120 containing a valve 115 retained by the retention unit. The engagement unit 120 may be associated with a pressurized fluid source, and the valve 115 of the engagement unit 120 may be configured such that the valve releases pressurized fluid upon engagement with the retention unit 130.

The engagement unit 120 generally has an outer surface 140 comprising a plurality of ears 110 and an interior surface having a plurality of pockets 150 corresponding to the plurality of ears, where each pocket retains a corresponding ear upon engagement.

Note that the mechanical support functions may be decoupled from the other functions of the retention unit 130. Accordingly, the mechanical retention grooves, or pockets 150, take the form of an insert 800 that becomes part of the retention unit 130. This mechanical support insert 800 may be formed from steel, or various other metals, and is outside of a gas (or liquid) sealing mechanism of the coupling 100, and may therefore be composed of separate parts without regard to sealing.

It is noted that the retention unit 120 may be provided with an insert 800 within a retention chamber, as shown, such that the features discussed may be provided either on the retention unit 130 itself or may instead be provided in the insert 800 which is then fixed within the retention chamber. For ease of illustration, FIGS. 2A-2B are shown in terms of the insert 800 and the rest of the retention unit 130 is not shown. Such an approach allows for the manufacture of the complex geometries of the pockets 150 described in an insert 800 instead of within an interior chamber of a larger retention unit 130.

In some embodiments, the retention unit 130 further comprises a gasket chamber 810 containing a gasket 820 that seals against an upper edge 155 of the engagement unit 120. These components are discussed in more detail below.

In order to engage the engagement unit 120 with the retention unit 130, the engagement unit is moved in an engagement direction 160, where the engagement unit is moved towards the retention unit. The engagement unit 120 is then rotated in a first direction 170 relative to the retention unit 130 in order for the ears 110 of the engagement unit to engage with the pockets 150 of the retention unit. As discussed in more detail below, upon engaging, the engagement unit 120 returns slightly in a disengagement direction 180 opposite the engagement direction 160 in order to seat each ear 110 in a corresponding pocket 150 in the receptacle.

Accordingly, movement of the engagement unit 120 in an engagement direction 160 brings an upper surface 155 of the engagement unit 120 into contact with a bearing surface 880 of the gasket 820.

In order to disengage the engagement unit 120 from the retention unit 130 or receptacle, the engagement unit is moved slightly in the engagement direction 160 in order to lift the ears 110 out of the corresponding pockets 150. This movement is generally against resistance of gravity and the gasket 820 The engagement unit 120 is then rotated in a second direction 190 opposite the first direction 170, and is then moved in the disengagement direction 180.

In the embodiments discussed below, the engagement unit 120 and retention unit 130 or receptacle are shown in an upright configuration. Accordingly, the engagement direction 160 is typically shown and described as an upper direction and the disengagement direction 180 is shown and described as a lower direction. Similarly, the engagement side of elements on the engagement unit may be referred to as upper sides and the disengagement side of elements may be referred to as lower sides.

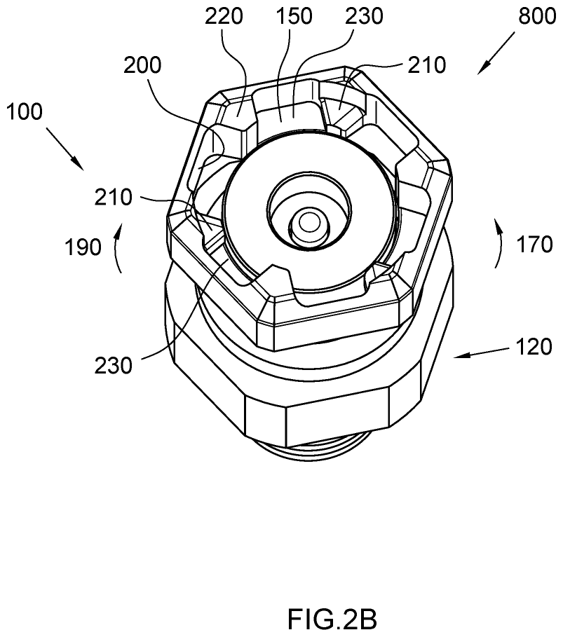

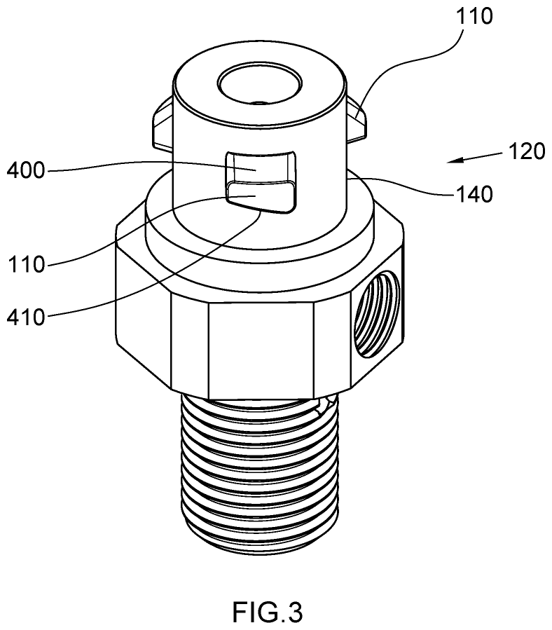

FIG. 3 shows a three eared 110 arrangement for an engagement unit 120. In traditional bayonet-type coupling mechanisms, the ears may be cylindrical pins or symmetrical tangs of simpler shape. Here, as shown, various aspects of the shape of the ears 110 provide benefits, described in detail in reference to FIGS. 3 and 4. As shown, the engagement unit 120 itself typically has a cylindrical outer surface 140 on which the ears 110 shown are located.

As shown in FIGS. 1 and 2A, the insert 800 of the retention unit 130 has an interior surface 200 for surrounding at least a portion of the engagement unit 120. The interior surface 200 comprises a plurality of pockets 150 as discussed above, where each pocket retains a corresponding ear 110 when engaged. Each pocket 130 has a first sidewall 210, such that when the engagement unit 120 is moved in the engagement direction 160, each ear 110 passes a sidewall 210 of the corresponding pocket 150.

Each pocket 130 may further have a second sidewall 220 and a base surface 230. The second sidewall 220 may then extend from the base surface 230 to a limiting surface 240 of the retention unit 120. The limiting surface 240 is generally provided on the retention unit 120 and not on the insert 800, and is therefore visible in FIG. 1. The first sidewall 210 may then extend only partially from the base surface 230 towards the limiting surface 240, such that the ear 110 may pass through a gap between the first sidewall 210 and the limiting surface 240.

The engagement unit 120 is then rotated in the first direction 170 to engage with the retention unit 130 while the ears 110 are located past the corresponding sidewalls 210. Upon engagement, the engagement unit 120 returns in the disengagement direction 180 such that the sidewalls 210 prevent each ear 130 from rotating in the second direction 190 and exiting the corresponding pocket 150.

Accordingly, each pocket 150 may have a base surface 230, a first side surface 210, and a second side surface 220, wherein the first side surface extends from the base surface to a limiting surface 240 of the retention unit 120, and wherein the second side surface extends only partially towards the limiting surface.

Similarly, during disengagement, the engagement unit 120 is moved slightly in the engagement direction 160 to move the ears 110 past the sidewalls 210 prior to rotating the engagement unit in the second direction 190 relative to the retention unit 130.

FIG. 4 shows an elevation view of the engagement unit 120 including an ear 110 of the coupling 100. As shown, each ear 110 has a first surface 400 on an engagement side, i.e., an upper surface, adjacent the outer surface 140 of the engagement unit 120 and a second surface 410 on a disengagement side, i.e., a lower surface, opposite the engagement side. The second surface 410 may be angled relative to a horizontal plane perpendicular to a length of the engagement unit 120 in an axial direction.

As such, upon rotation of the engagement unit 120 in the first direction 170, the second surface 410 of each ear 110 bears on the sidewall 210 of the corresponding pocket 150 and forces the engagement unit into engagement with the retention unit when moved in the disengagement direction 180, unless the ear is fully clear of the sidewall.

This second surface 410 thereby allows a user to obtain mechanical assistance in twisting, to engage the engagement unit 120 with the retention unit 130 and have it seat securely in the pocket 150. Once each ear 110 is inserted past the sidewall 210, it is over the maximum axial travel in the engagement direction 160, and the angled second surface 210 acts as a ramp. Downward axial forces in the disengagement direction 180 may be produced by the compression of a gasket 820, discussed below, and by gravity. Such forces then cause the coupling 100 described to seek engagement.

Accordingly, once insertion of the engagement unit 120 into the retention unit 130 has occurred, and once a user has begun to rotate the engagement unit in the first direction 170, it becomes easier to secure the coupling 100, rather than having to fight increased force to come to a locked or secure position.

Additionally, if the engagement unit 120 is not fully engaged and seated in the secure position within the retention unit 130, releasing the engagement unit 120 will produce more force to drive the ears 110 into the fully locked position. This is distinct from most bayonet or twist lock designs, where if a full mechanical engagement is not produced prior to application of pressure, the coupling will disengage, usually resulting in a full leak or physical projection of one or both sides of the coupling. The coupling 100 described herein will instead drive itself into the locked and secure position. Similarly, a helical screw will tend to back itself out under pressure if not sufficiently secured and if the thread engagement is not sufficiently tight. The described embodiment 100 gives the user positive feedback on the state of the engagement (secure vs not secure) and not only prevents unintended leaky operation, but also prevents an unsafe condition where an incompletely engaged valve may become partially pressurized and release unexpectedly, becoming a projectile.

As shown, the second surface 410 slopes from the engagement side to the disengagement side of each ear 110, such that at a first engagement end 420 of the slope, the second surface 410 is closest to the first surface 400 and at a second disengagement end 430 of the slope, the second surface is farthest from the first surface. As shown, a transition from the engagement end 420 of the second surface 410 to a corresponding first side surface 440 of the ear 110 has a first radius 450. The transition from the disengagement end 430 of the second surface 410 to a corresponding second side surface 455 of the ear 110 has a second radius 460. In the embodiment shown, the second radius 460 is larger than the first radius 450. It is further noted that because the angle between the engagement end 420 of the second surface and the first side surface 440 is obtuse and the angle between the disengagement end 430 and the second side surface 455 is acute, the second radius 460 also forms a larger arc than the first radius 450, in addition to being a larger radius.

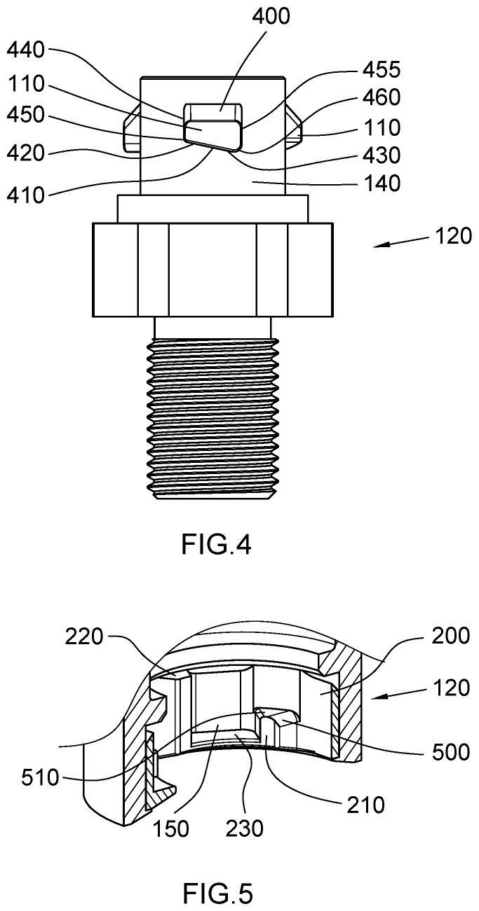

FIG. 5 shows a sectioned view of a portion of the retention unit 130. As shown, the sidewall 210 has asymmetric radii to control the insertion and removal of the ears 110 from the corresponding pockets 150 during engagement and disengagement.

The larger second radius 460 of the ear 110 is at the disengagement end 430 of the second surface 410 of the ear 110. However, it comes into contact with an engagement portion 500 of the retention unit 120 having a first radius. In contrast, a disengagement portion 510 of the retention unit 120 adjacent the pocket 150 has a second radius smaller than the first radius.

During engagement, the larger second radius 460 of the ear 110 meets the larger radius engagement portion 500 of the sidewall 210 of the pocket 150. When these two surfaces 460, 500 meet, their large radii allow for ease of engagement, as the surfaces may slip by each other more efficiently than if these had smaller radii. The large radius 460 on the valve body ear 110 allows more rapid insertion since the surface falls away from the flat sidewall 450 at the side quickly. The tolerances are adjusted so that misalignment is allowed for ease of insertion, and the large radius 460 at this location on each ear serves to increase allowed misalignment and facilitate sliding contact, with or without lubricant. Further, damage to the large radius 460 that could hamper insertion or engagement is less likely than with a more fragile smaller radius, which would produce more of a sharp corner that could be more easily deformed.

Returning now to FIG. 4, the first radius 450 at the transition from the engagement end 420 of the second surface 410 to the first sidewall 440 is smaller than the second radius 460.

The smaller first radius 450 shown has several reasons. Initially, the smaller radius 450 allows only a small amount of travel before engagement of the second surface 410 of the ear 110 with the corresponding disengagement portion 510 of the sidewall 210 of the retention unit 130. This allows a user to feel a secure feedback as the ear 110 drops into place past the disengagement portion 510, without it being a large movement that requires space and potentially could cause injury by having a longer span over which to accelerate under gasket forces and gravity, before making contact.

However, the transition between the second surface 410 and the first sidewall 440 of the ear 110 is not a sharp corner. Accordingly, on disengagement the user is able to feel the small first radius 450 start to ride over the disengagement portion 510 of the first sidewall 210 of the corresponding pocket 150. As such, the first radius 450 may meet with a matching radius, or similarly small radius, at the disengagement surface 510 on the inner edge of the sidewall 210. This displacement is felt prior to being back on the “ramp” portion of the ear 110 formed by the second surface 410. This allows the user to understand that disengagement is about to commence just prior to it commencing. In the event that the user lets go at that point, the ears 110 would lock back into place within the corresponding pockets 150, as they are under pressure from the gasket and from gravity.

Further, when the coupling 100 is fully engaged and pressurized, it is extremely difficult to displace the valve in the axial disengagement direction 160 to begin disengagement, and such attempted disengagement could be dangerous. If the first radius 450 were replaced with a sharp corner, it might be easier to jolt the engagement unit 120 into a position where the edge could catch. It would still be very difficult to fight the ramp and fully disengage the valve under pressure, but with a radiused edge there is no danger of an intermediate catch. Instead the coupling simply reseats. As with the larger second radius 460 discussed above, the smaller first radius 450 is much more resistant to damage and more conducive to sliding contact, than is a sharp corner.

On disengagement the ramped second surface 410 of the ears 110 allow for mechanical advantage for a user to disengage the coupling by twisting. Accordingly, when the second surface 410 of each ear 110 bears on the corresponding first sidewall 210, if the engagement unit 120 is then rotated in the second direction 190 during disengagement, the engagement unit is forced in the engagement direction 160 until the ear 110 is clear of the sidewall 210. This allows for tactile feedback during disengagement in the form of pressure buildup, such that force will slowly build until each ear 110 is clear of the corresponding sidewall 210, at which point the coupling 100 will disengage. At all times, the coupling 100 thereby provides certainty as to the current state of the valve assembly.

Twisting is far easier than pushing in the engagement direction 160 in order to achieve the full displacement needed for disengagement. The user need only push the engagement unit 120 a short distance in the engagement direction 160, to where the sidewall 210 and ear 110 radii 450, 510 meet, after which the ramped second surface 410 is in contact and twisting can be the main action used to produce the required axial motion. Additionally, because there are three ears 110 and some mechanical tolerance, it is possible to use two seated ears 110 as an off-center fulcrum to begin to disengage the third ear 110 only, easily. From there the second ear 110 may be disengaged, followed by the third as twisting is underway. Consequently, starting the disengaging motion is relatively easy despite the secure nature of the coupling 100.

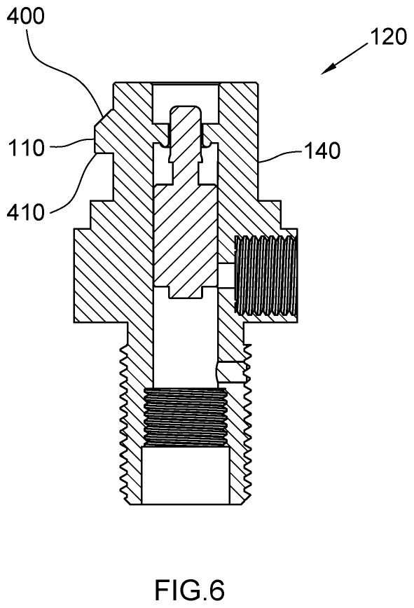

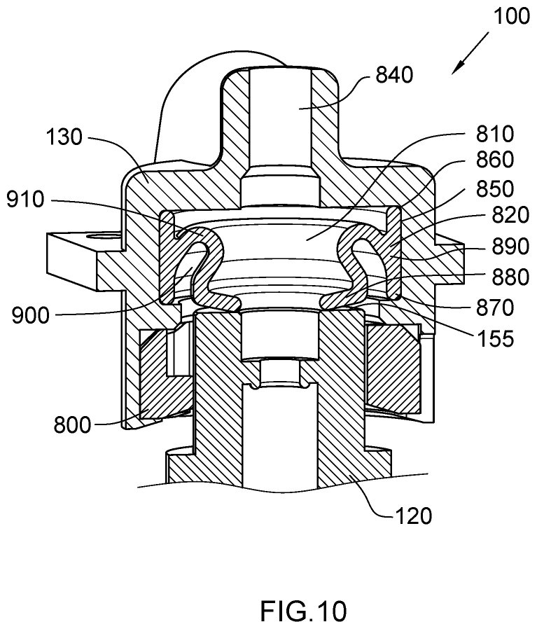

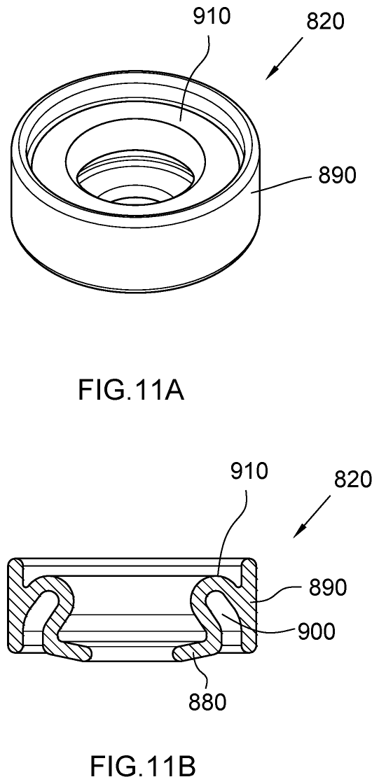

FIG. 6 shows a cross section of the engagement unit 120 including one of the ears 110 on the engagement unit 120. In the cross section of the ear 110, it can be seen that the first surface 400 is chamfered relative to the horizontal plane of the engagement unit 120. Pictured is a planar chamfer, however in another incarnation of this design, the chamfer may follow the cylindrical curve of the valve body. As is discussed below in reference to FIGS. 10 and 11, the retention unit 130 may have a limiting surface 240 having a chamfer at a substantially similar angle to that of the first surface 400 of the ear 110.

Among the reasons for providing a chamfer are the following. This chamfer of the first surface 200, provided on all three ears 100 of the engagement unit 120, describes an incomplete cone that allows rapid finding of the insertion point such that insertion of the engagement unit 120 can easily be located axially in the retention unit 110. The retention unit 110, described in more detail below, has a concavity of a similar conical shape defined by the limiting surface 240. These chamfers fit into the truncated cone formed by that limiting surface 240 and any contact creates a centering effect that allows a user to find, by feel alone, a correct valve alignment. It then becomes natural, once centered, to twist 60 degrees in either direction 170, 190 to engage or disengage the coupling 100.

A second reason for this chamfer is to increase the cross sectional area of the corresponding ear 110, thereby allowing far more stress to be distributed to the surface 140 of the engagement unit 120. This makes the ear 110 itself less fragile and more capable of bearing mechanical stress without failure during use.

A third reason for this chamfered surface 400 is to provide a surface that is not orthogonal to the axis of the valve, for the purpose of damage control. A valve with a flat surface is more prone to damage due to wear by contaminants during usage, or by impacts during shipping or general handling. An imperfection caused by impact may have a deleterious effect on the operation of the retention mechanism. The chamfer provides a surface 400 that under contaminant wear conditions, tends to shed contaminants outwards. This reduces damage at the root of the ear 110, and allows most wear to occur at the outer top surface of the chamfer 400, where it is allowed, and where it has the least effect on interfering with the retention mechanism. Similarly, for impact damage, the chamfer provides a surface 400 more likely to deflect an impact, rather than absorbing all of the energy of an impact, which would result in damage or deformation. The angled surface allows for more careless handling of the coupling 100, converting impacts to glancing blows with less probability of resultant severe damage.

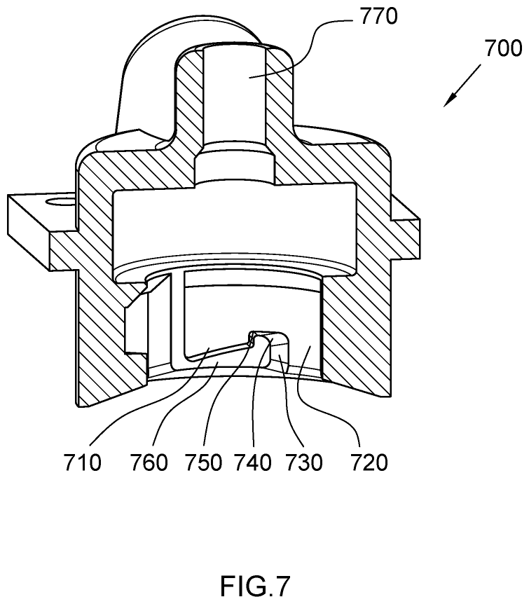

FIG. 7 shows a sectioned view of a second embodiment of a retention unit 700 for retaining an engagement unit 120 of a coupling in accordance with this disclosure. In the embodiment shown, many of the same features discussed above with respect to the retention unit 130 of FIG. 1 are provided. As such, the retention unit 700 includes pockets 710 that are engaged by ears 110 of the engagement unit 120. The retention unit 700 has an interior surface 720 for surrounding at least a portion of an engagement unit 120 retained therein, with the interior surfaces containing the pockets 710.

In contrast with the embodiment 130 of FIG. 1, the structure of the pockets 710 in the retention unit 700 shown is embedded in the retention unit itself, rather than separately manufactured in an insert 800. Further, each pocket 710 of the retention unit 700 has a sidewall 730, which may have angled engagement portions 740 and disengagement portions 750 having varied radii, as discussed above with respect to FIG. 5. However, the retention unit 700 shown may further comprise a base surface 760 angled relative to the horizontal plane of the engagement unit 120 when the engagement unit is engaged. The slope of the angled base surface 760 may be substantially similar to that of the second surface 420 of the ears 110 of the retention unit 120, such that when the ears 110 are seated in corresponding pockets 710, the slopes of the base surface 760 and the second surface 420 are substantially parallel and rest against each other.

In alternative embodiments, such as the retention unit 130 discussed above and below, the pockets 150 may be provided with base surfaces 230, but the base surfaces may be horizontal rather than sloped. It will be understood that while the sloped base surfaces 760 are shown in the retention unit 700 of FIG. 7 and the insert 800 is shown in the embodiment 100 of FIG. 1, an insert may be provided with sloped base surfaces, and the horizontal base surfaces 230 of FIG. 1 may be provided integrated into the retention unit 130, 700 in various embodiments.

The retention unit 130, 700 provides several functions. Not only does it provide mechanical support and several of the locking elements, in the form of pockets 150, 710 for the coupling 100, but it also provides a channel 770, 810 for fluid conveyance, typically gas but liquid is possible as well. It also provides a housing 780 for a flexible seal for the coupling 100, taking the form of a gasket 820, discussed in more detail below.

It may optionally provide a pass through mechanism for depressing a valve pin, if no such mechanism exists on the engagement unit 120 of the coupling. Such a pass through is typically required for CO2 systems, where no valve triggering mechanism is included in the compressed gas canister. The retention unit 130, 700 may also optionally provide a location for sensors or other metering devices.

Note that the engagement unit 120, may then comprise a valve associated with a pressurized fluid source, such that the valve releases pressurized fluid upon engagement with the retention unit 130, 700. It will be understood that while a specific configuration is shown and described, in some embodiments, the valve may be integrated into the retention unit, such that the female portion of the coupling contains the valve elements.

Note that with respect to the mechanical retention aspects of the retention unit 700, the shape of the pockets 710 of the retention unit 700 of FIG. 7 may be close to the negative space of the valve ears 110 of the engagement unit 120, with channels for entry and exit.

In FIG. 7, the ramp of the valve ear 110 is mirrored and in the engaged position the ramped base surface 760 of the receptacle 710 matches up with the ramped second surface 410 of the valve ear 110 and supports it along its entire length. While this is an advantage, it may be difficult to manufacture such a complex internal shape, and it is not required.

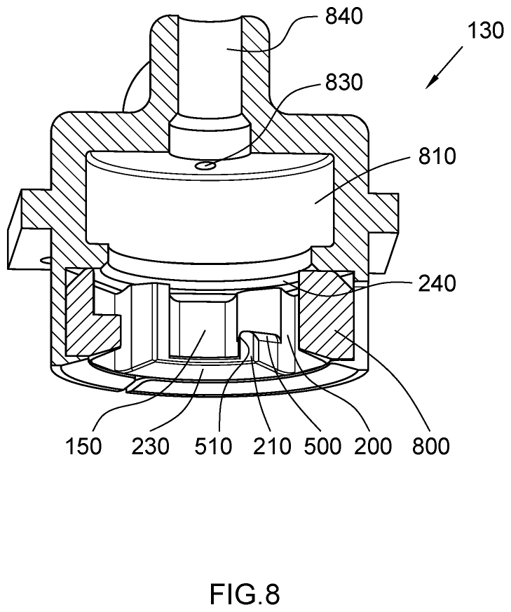

As such, FIGS. 8-11 relate to the embodiment of the retention unit 130 discussed above with respect to FIG. 1. As shown all channels and surfaces, including that of the base surface 230, are parallel and linear, without complex geometry save for the aforementioned radial surfaces 500, 510. It is further noted that various features having complex geometries may be optional as well. Accordingly, the various radii described may be applied only on the retention unit 130 side or only on the engagement unit 120 side. This will provide many of the benefits described above while simplifying at least a portion of the manufacturing process, such that the manufacturing of the engagement unit 120, for example, can be relatively linear.

In some embodiments, more complex features are applied on the engagement unit 120, since manufacturing of the engagement unit may be easier. As there are no undercuts, it may be easier to manufacture complex features. Further, because the engagement unit 120 may be designed to be discardable or interchangeable, the component may be discontinued from use if any portion is no longer viable. In contrast, the retention unit 130, may be part of an appliance installation, and therefore not easily replaceable. Accordingly, it is advantageous that more complex and delicate features be incorporated into the engagement unit 120 side of the coupling.

However, for all of the features described that ease the fixation of the coupling 100, the features may be applied to only one of the engagement unit 120 or receptacle / retention unit 130. Accordingly, the conical shape of the chamfer of the first surface 400 of the ears 110 on the engagement unit 120 may be coupled with or replaced by angled surfaces on the retention unit 130. Similarly, the ramped second surface 410 of the ears 110 of the engagement unit 120 may be coupled with or replaced with a ramped surface on the sidewall 210 of the pockets 150 of the retention unit 130.

In embodiment shown in FIG. 8, the large radius 460 on the engagement unit 120 is supported by the base surface 230 of the pocket 150 of the retention unit 130 instead of ramp-to-ramp contact. This is sufficient if the material properties support this without damage or distortion. The engagement unit 120 may be made of brass, for example, and the mechanical parts of the retention unit 130 may be made of stainless steel or a similar material. However, it will be understood that a wide variety of materials are contemplated.

As shown, the retention unit 130 has a limiting surface 240, which is chamfered to correspond to the first surface 400 of the ears 110. The limiting surface 240 then limits the travel of the ears 110 in the engagement direction 160. The retention unit 130 also provides a sealing gasket chamber 810 for locating a sealing gasket 820, which is discussed in more detail below.

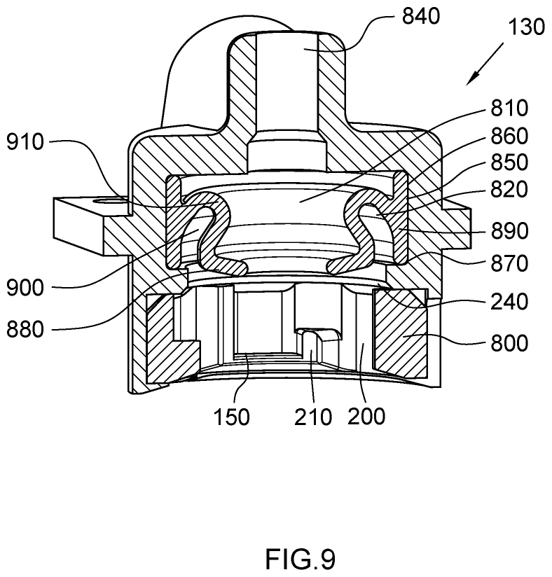

FIG. 9 shows the retention unit 130 of FIG. 8 including a sealing gasket 820. FIGS. 11A and 11B show the gasket 820 in perspective and sectioned views respectively.

In FIG. 9, other aspects of the retention unit 130 may also be seen. The top hole 830 may provide access to a channel 840 which a pin may then enter, but which may be otherwise sealed via o-rings. This pin may be an actuation pin that can depress a valve pin once the coupling 100 is fully engaged. Also visible is the upper chamber, referred to herein as a gasket chamber 810, which houses the sealing gasket 820. The sealing gasket 820 has a complex shape, shown here in cross section, installed in the upper gasket chamber 810.

The gasket 810 may be slightly oversized in its cylindrical diameter, so that there is some residual compression at the outer periphery. This creates a gas seal between the gasket 820 and a cylindrical inner surface 850 of the gasket chamber 810. Under pressure, this seal is concentrated at a top edge 860 of the inner surface 850, as the lower edge 870 is at atmospheric pressure. Additionally, when the engagement unit 120 is inserted, a bearing surface 880 of the gasket 120 is deflected upward, causing more outward force at the top surface 155 of the engagement unit.

The top surface 155 of the engagement unit 120 is then a sealing surface, as with a traditional helical coupling design. However in this case the top surface 155 does not squeeze a polymer material to create a seal. Instead, the shape of the gasket 820 is such that as it is deflected upward by the axial motion of the engagement unit 120 in the engagement direction 160. The bearing surface 880 of the gasket 820 then contacts the top surface 155 of the engagement unit 120 creating a seal, and the contact patch of this bearing surface 880 then increases in area as the gasket 820 is deflected upward. In the final position, the gasket's 820 bearing surface 880 is fully in contact with the engagement unit's 120 upper surface 155. This arrangement is highly tolerant of misalignment, and is highly compliant, making valve insertion easy, but providing enough resistance to force the engagement unit 120 into engagement as previously described.

As such, when the retention unit 130 is disengaged and the gasket 820 is at rest, the bearing surface 880 of the gasket slopes radially, such that it is angled downward towards a central axis of the retention unit 130.

When the retention unit 130 is pressurized, the gasket chamber 810 is pressurized first, and the inflation forces inside the gasket 820 force a base surface 890 at the outer upper portion of the gasket outward against the cylindrical inner surface 850 of the gasket chamber 810. Further, the pressure of the fluid forces the bearing surface 880 downward against the top surface 155 of the engagement unit 130. The space 900 within the curved part of the gasket 820 on the underside, outward of the engagement unit 120, is at atmospheric pressure, and the pressurized gasket 820 is backed by the mechanical structure of the retention unit 120 and the engagement unit 130. As such, only a small gap, between the retention unit 120 and the engagement unit 130, is unsupported.

Should an overpressurization occur, the curved surface 910 shown in the gasket 820 would begin to flatten, but the gasket is generally curved against the tendency to inflate, and cannot rupture. In the extreme, if the void 900 were to be fully compressed, it would amount only to a wall doubling and still be backed by structural members 120, 130. The material and dimensions are chosen so that at this maximum deflection, the innermost ring of valve contact area does not experience a material failure or tear.

As shown, the gasket 820 typically has a bearing surface 880 for bearing against an end 155 of the engagement unit 120 when the engagement unit is engaged with the retention unit 130, a base element 890 for fixing the sealing gasket 820 relative to the retention unit, and a flexible membrane 910 extending from the base element to the bearing surface. During use, the sealing gasket chamber 810 is pressurized by the retention unit 130, and when under pressure, the bearing surface 880 of the gasket 820 is forced against the end 155 of the engagement unit 120, and the flexible membrane 910 forms an inflatable wall of the sealing gasket chamber 810. As shown, the bearing surface 880 is generally substantially circular, and may slope downwards towards a central axis of the retention unit 130 when at rest, and the base element 890 which fixes the gasket 820 to the retention unit may be outside of the radius of the bearing surface 880.

In many embodiments, such as that shown, the shape of the gasket 820 biases the bearing surface 880 in the direction of the end 155 of the engagement unit 120, such that when initially connected, but not yet pressurized, the components are sealed. The initial sealing allows for pressurizing the sealing gasket chamber 810, thereby increasing the force of the bearing surface 880 on the end 155 of the engagement unit120 once pressurized.

In some embodiments, the sealing gasket chamber 810 may further contain a spring for biasing gasket 820 in the direction of the bearing surface 880. In this way, the bearing surface 880 may naturally bear against the end 155 of the engagement unit 120 when at rest with additional force. This approach minimizes risk that the bearing surface 880 does not fully seal against the end 155 of the engagement unit 120 when not pressurized. Failure to seal when not pressurized may prevent the gasket from sealing as pressure increases, resulting in a leak.

FIG. 10 shows the receptacle of FIG. 8 and an end 155 of an engagement unit 120 coming into contact with the gasket 820.

As the engagement unit 120 travels upward, or in an engagement direction 160, the gasket 820 is compressed, and both upper outer cylinder surface 850 and the mating surface 155 at the top of the engagement unit seal due to compressive forces. Adding pressure due to release of compressed gas inside the gasket only adds to these pressures and reinforces the seals.

It can be seen that an actuation pin has a clear path from above to directly depress a valve pin downward. Such actuation pin may have a sliding O-ring contact to provide a positive gas seal in this area. Once gas is in this area it may be released through an exit port 1100.

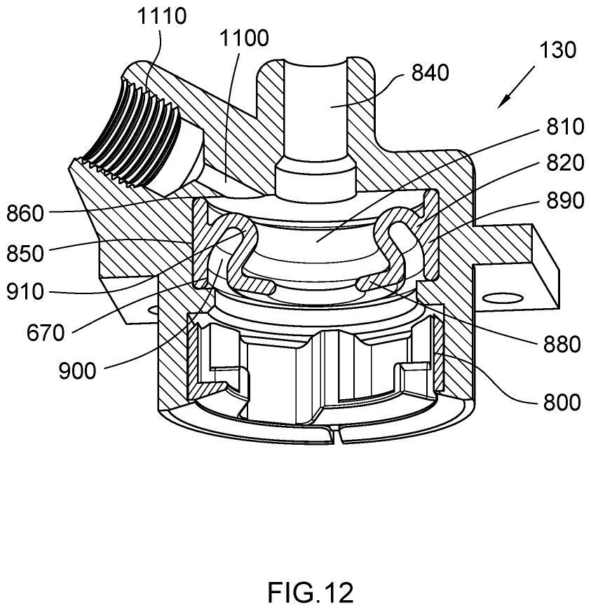

FIG. 12 shows a second section view of the retention unit 130 of FIG. 10. In this view a port 1100 is fitted with a standard fitting thread 1110, and from there may be attached to tubing to convey the fluid elsewhere.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A fluid coupling comprising:
a retention unit; and
an engagement unit for being retained by the retention unit;
the engagement unit having an outer surface comprising a plurality of ears; and
the retention unit having an interior surface for surrounding a portion of the engagement unit, the interior surface comprising a plurality of pockets corresponding to the plurality of ears, wherein each pocket retains a corresponding ear;
wherein the engagement unit is moved in an engagement direction such that each ear passes a sidewall of the corresponding pocket and is rotated in a first direction to engage with the retention unit, and the engagement unit is rotated in a second direction opposite the first direction and moved in a disengagement direction opposite the engagement direction to disengage with the retention unit;
wherein each ear has a first surface on an engagement side adjacent the outer surface of the engagement unit and a second surface on a disengagement side opposite the engagement side adjacent the outer surface of the engagement unit;
wherein the second surface is angled relative to a horizontal plane perpendicular to a length of the engagement unit such that upon rotation of the engagement unit in the first direction, the second surface of each ear bears on a sidewall of the corresponding pocket and forces the engagement unit into engagement with the retention unit.

2. The fluid coupling of claim 1, wherein the second surface slopes from an engagement side to a disengagement side, and wherein a transition from an engagement end of the slope closest to the first surface to a first side surface of the corresponding ear has a first radius, and wherein a transition from a disengagement end of the slope farthest from the first surface to a second side surface of the corresponding ear has a second radius larger than the first radius.

3. The fluid coupling of claim 1, wherein the engagement unit comprises a valve and is associated with a pressurized fluid source, such that the valve releases pressurized fluid upon engagement with the retention unit.

4. The fluid coupling of claim 1, wherein the first surface of each ear is chamfered relative to the horizontal plane of the engagement unit.

5. The fluid coupling of claim 4, wherein the retention unit has a limiting surface having a chamfer at a substantially similar angle to that of the ears.

6. The fluid coupling of claim 1, wherein each pocket has a base surface, a first side surface, and a second side surface, wherein the first side surface extends from the base surface to a limiting surface of the retention unit, and wherein the second side surface extends only partially towards the limiting surface.

7. The fluid coupling of claim 6, wherein the base surface is angled relative to the horizontal plane when the engagement unit is engaged such that it has a slope substantially similar to that of the second surface of the corresponding ear.

8. The fluid coupling of claim 1, wherein the retention unit has a limiting surface limiting the travel of the ears in the engagement direction, and wherein the retention unit has a sealing gasket chamber for locating a sealing gasket.

9. The fluid coupling of claim 8 further comprising a sealing gasket, wherein the sealing gasket has:
a bearing surface for bearing against an end of the engagement unit when the engagement unit is engaged by the retention unit, a base element for fixing the sealing gasket relative to the retention unit; and
a flexible membrane extending from the base element to the bearing surface.

10. The fluid coupling of claim 9 wherein the sealing gasket chamber is pressurized by the retention unit, and wherein under pressure the bearing surface is forced against the end of the engagement unit and the flexible membrane forms an inflatable wall of the sealing gasket chamber.

11. The fluid coupling of claim 9 wherein the bearing surface is substantially circular, and wherein the base element is outside of the radius of the bearing surface.

12. The fluid coupling of claim 11 wherein the base element has a base surface for engaging the retention unit substantially perpendicular to the bearing surface.

13. The fluid coupling of claim 9, wherein the bearing surface is substantially circular and slopes radially, such that it is angled downward relative to a central axis of the retention unit.

14. The fluid coupling of claim 9 further comprising a spring within the sealing gasket chamber for biasing the sealing gasket in the direction of the bearing surface.

15. A gasket for sealing a fluid coupling, the gasket comprising:
a bearing surface for bearing against a surface of a first element to be coupled;
a base element for fixing the sealing gasket to a second element to be coupled;
a flexible membrane extending from the bearing surface to the base element.

16. The gasket of claim 15, wherein the second element side of the gasket is pressurized, and wherein under pressure the bearing surface is forced against the surface of the first element to be coupled.

17. The gasket of claim 16, wherein under pressure, the flexible membrane forms an inflatable wall of a sealing gasket chamber.

18. The gasket of claim 15, wherein the bearing element is substantially circular, and wherein the base element is outside of the radius of the bearing surface.

19. The gasket of claim 18, wherein the base element has a base surface for engaging the second element, wherein the base surface is substantially perpendicular to the bearing surface.

20. The gasket of claim 15, wherein the bearing surface is substantially circular and slopes radially, such that it is angled downward relative to a central axis of the gasket.
